(19) United States
(12) Patent Application Publication
(10) Pub. No.: US 2026/0143412 A1
(43) Pub. Date: May 21, 2026

(54) INFORMATION PROCESSING SYSTEM, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Kazuhito ESHIMA, Toyota-shi (JP); Hidenobu KINUGASA, Nagoya-shi (JP); Takahiro YAMAMOTO, Toyota-shi (JP); Tatsuya SUGANO, Seto-shi (JP)

(73) Assignee: TOYOTA JIDOSHA KABUSHIKI KAISHA, Toyota-shi (JP)

(21) Appl. No.: 19/361,819

(22) Filed: Oct. 17, 2025

(30) Foreign Application Priority Data
Nov. 15, 2024 (JP) 2024-199564

(51) Int. Cl. H04W 48/04; B60W 30/095; H04W 4/44

(52) U.S. Cl. CPC H04W 48/04; B60W 30/095; H04W 4/44

(57) ABSTRACT

An information processing system acquires information on a radio wave intensity distribution of each of a plurality of access points and information on a traveling path of a vehicle in a predetermined area in which the plurality of access points is provided. The information processing system calculates a risk at a target position on the traveling path of the vehicle and calculates an access point switching tolerance at the target position based on the radio wave intensity distribution and the risk. The access point switching tolerance becomes lower as the risk at the target position becomes higher. The information processing system prohibits switching of a target access point to which the vehicle is to be connected at the target position at which the access point switching tolerance is less than a threshold.

### CROSS-REFERENCE TO RELATED APPLICATION

This application claims priority to Japanese Patent Application No. 2024-199564 filed on November 15, 2024. The disclosure of the above-identified application, including the specification, drawings, and claims, is incorporated by reference herein in its entirety.

### BACKGROUND

### 1. Technical Field

The present disclosure relates to an information processing technology to be applied to a vehicle connected to an access point of a wireless communication network, and more particularly, to an information processing system, an information processing method, and a non-transitory storage medium.

### 2. Description of Related Art

Japanese Unexamined Patent Application Publication No. 2018-77652 (JP 2018-77652 A) discloses a vehicle driving support system. The vehicle driving support system includes a communication unit that performs wireless communication, and a driving control unit that performs automated driving control based on information acquired via the communication unit.

### SUMMARY

A vehicle to be connected to an access point of a wireless communication network in a predetermined area will be considered. A target access point is one of a plurality of access points provided in the predetermined area, to which the vehicle is to be connected. When the vehicle travels in the predetermined area, the vehicle performs wireless communication while switching the target access point. However, wireless communication is interrupted for a moment at a switching timing of the target access point, and thus, it is desired to appropriately control switching of the target access point in accordance with a condition.

A first aspect relates to an information processing system. The information processing system is to be applied to a vehicle that travels in a predetermined area in which a plurality of access points is provided. The information processing system includes one or more processors. The one or more processors are configured to acquire information on a radio wave intensity distribution of each of the plurality of access points, acquire area management information indicating a condition of the predetermined area, acquire information on a traveling path of the vehicle in the predetermined area, calculate a risk at a target position on the traveling path based on at least the area management information, calculate an access point switching tolerance at the target position based on the radio wave intensity distribution and the risk, and prohibit switching of a target access point to which the vehicle is to be connected at the target position at which the access point switching tolerance is less than a threshold. The access point switching tolerance at the target position becomes lower as the risk at the target position becomes higher.

In the information processing system in the first aspect, the area management information may include obstacle information indicating a position of an obstacle within the predetermined area, the one or more processors may be further configured to calculate a margin between the vehicle at the target position and the obstacle around the target position, and the risk at the target position may become higher as the margin at the target position becomes smaller.

In the information processing system in the first aspect, the area management information may include information on a scheduled traveling path of another vehicle within the predetermined area, and the risk when the target position is located on the scheduled traveling path may be higher than the risk when the target position is not located on the scheduled traveling path.

In the information processing system in the first aspect, the area management information may include obstacle information indicating a position of an obstacle within the predetermined area, the one or more processors may be further configured to acquire vehicle information including at least a position and a speed of the vehicle, and calculate a time to collision (TTC) between the vehicle at the target position and the obstacle around the target position based on the obstacle information and the vehicle information, and the risk at the target position may become higher as the TTC at the target position decreases.

In the information processing system in the first aspect, a first position may be a future position of the vehicle on the traveling path, and the one or more processors may be configured to decelerate the vehicle before reaching the first position when radio wave intensity of the target access point at the first position is less than a first threshold.

In the information processing system in the first aspect, the predetermined area may be a parking lot, and the vehicle may include a function of automated valet parking.

A second aspect relates to an information processing method to be executed by a computer. The information processing method is to be applied to a vehicle that travels in a predetermined area in which a plurality of access points is provided. The information processing method includes acquiring information on a radio wave intensity distribution of each of the plurality of access points, acquiring area management information indicating a condition of the predetermined area, acquiring information on a traveling path of the vehicle in the predetermined area, calculating a risk at a target position on the traveling path based on at least the area management information, calculating an access point switching tolerance at the target position based on the radio wave intensity distribution and the risk, and prohibiting switching of a target access point to which the vehicle is to be connected at the target position at which the access point switching tolerance is less than a threshold. The access point switching tolerance at the target position becomes lower as the risk at the target position becomes higher.

A third aspect relates to a non-transitory storage medium that stores instructions to be applied to a vehicle that travels in a predetermined area in which a plurality of access points is provided, the instructions being executed by a computer and causing the computer to perform functions including acquiring information on a radio wave intensity distribution of each of the plurality of access points, acquiring area management information indicating a condition of the predetermined area, acquiring information on a traveling path of the vehicle in the predetermined area, calculating a risk at a target position on the traveling path based on at least the area management information, calculating an access point switching tolerance at the target position based on the radio wave intensity distribution and the risk, and prohibiting switching of a target access point to which the vehicle is to be connected at the target position at which the access point switching tolerance is less than a threshold. The access point switching tolerance at the target position becomes lower as the risk at the target position becomes higher.

According to the present disclosure, the access point switching tolerance at the target position on the traveling path of the vehicle is calculated in consideration of the "risk at the target position" as well as the radio wave intensity distribution. The access point switching tolerance becomes lower as the risk at the target position becomes higher. Further, at the target position at which the access point switching tolerance is less than the threshold, switching of the target access point is prohibited. Thus, at the position at which the risk is high, switching of the target access point is suppressed. In other words, at the position at which the risk is high, instantaneous interruption of wireless communication is suppressed. This is preferable in terms of vehicle control.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a conceptual diagram for describing an example of vehicle control in a predetermined area;

FIG. 2A is a conceptual diagram for describing an example of area management information;

FIG. 2B is a conceptual diagram for describing an example of the area management information;

FIG. 3 is a conceptual diagram for describing an example of access points and access point management information;

FIG. 4 is a conceptual diagram for describing an example of switching of a target access point;

FIG. 5 is a conceptual diagram for describing outline of an information processing system that executes communication-related processing;

FIG. 6A is a conceptual diagram for describing an example of a risk;

FIG. 6B is a conceptual diagram for describing another example of the risk;

FIG. 7 is a block diagram illustrating a functional configuration example related to risk calculation processing;

FIG. 8 is a block diagram illustrating a functional configuration example related to communication control processing in which a risk is taken into account;

FIG. 9 is a conceptual diagram indicating an example of an access point switching tolerance;

FIG. 10 is a block diagram illustrating a functional configuration example related to vehicle control processing in which a risk is taken into account;

FIG. 11 is a block diagram illustrating a configuration example of an in-vehicle system;

FIG. 12 is a block diagram illustrating a configuration example of a management system; and

FIG. 13 is a block diagram illustrating a configuration example of the information processing system.

### DETAILED DESCRIPTION OF EMBODIMENTS

An embodiment of the present disclosure will be described with reference to the accompanying drawings.

1. Vehicle Control in Predetermined Area

Control of a vehicle 1 in a predetermined area AR will be considered. Examples of the predetermined area AR can include a parking lot, a factory, a site of a facility, one town (smart city), and the like. In the predetermined area AR, the vehicle 1 is controlled to travel to a set destination. The vehicle 1 may be an automated driving vehicle.

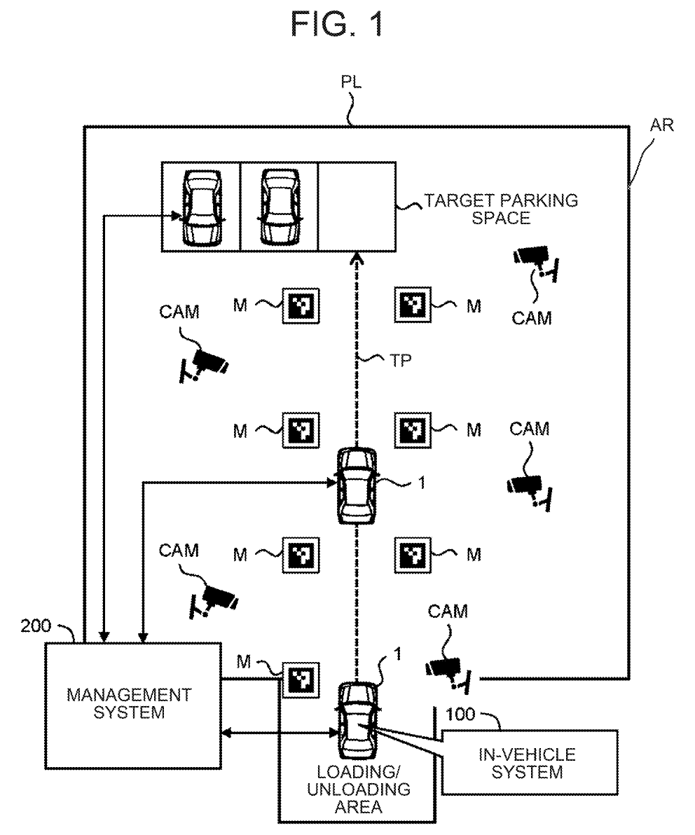

FIG. 1 is a conceptual diagram for describing an example of control of the vehicle 1 in the predetermined area AR. In the example illustrated in FIG. 1, the predetermined area AR is a parking lot PL. The parking lot PL provides an automated valet parking (AVP) service. The vehicle 1 has a function of performing automated valet parking and can autonomously travel at least within the parking lot PL.

An in-vehicle system 100 is mounted on the vehicle 1 and controls the vehicle 1. Specifically, the in-vehicle system 100 recognizes a condition around the vehicle 1 using a recognition sensor (for example, a camera) mounted on the vehicle 1. The in-vehicle system 100 causes the vehicle 1 to safely travel while recognizing the condition around the vehicle 1. A plurality of markers M (landmarks) may be provided within the parking lot PL. The markers M are used to guide the vehicle 1 within the parking lot PL. For example, the in-vehicle system 100 acquires an image of a circumference using the camera and recognizes the markers M based on the image. Then, the in-vehicle system 100 performs localization processing that estimates a position of the vehicle 1 in the parking lot PL with high accuracy based on the recognition result of the markers M. The in-vehicle system 100 causes the vehicle 1 to autonomously travel within the parking lot PL based on the estimated vehicle position.

A management system 200, which is a system that manages the parking lot PL (predetermined area AR) and automated valet parking, is arranged outside the vehicle 1. The management system 200 can perform communication with each vehicle 1 within the parking lot PL. For example, the management system 200 performs communication with each vehicle 1 within the parking lot PL via a wireless LAN. The management system 200 may remotely operate each vehicle 1 within the parking lot PL.

One or more infrastructure cameras CAM may be provided within the parking lot PL. The infrastructure camera CAM captures an image of the parking lot PL and acquires the image indicating a condition of the parking lot PL. The management system 200 performs communication with the infrastructure camera CAM to acquire the image captured by the infrastructure camera CAM. The management system 200 detects the vehicle 1 in the image by analyzing the image. Further, the management system 200 estimates a position of the vehicle 1 in the image. Still further, the management system 200 manages the vehicle 1 within the parking lot PL based on the position of the vehicle 1. The management system 200 may provide position information of the vehicle 1 to the vehicle 1. The in-vehicle system 100 of the vehicle 1 may cause the vehicle 1 to autonomously travel within the parking lot PL based on the position information provided from the management system 200.

Loading processing is as follows. The vehicle 1 stops in a loading area. The management system 200 allocates an available parking space to the vehicle 1. The allocated available parking space becomes a target parking space, that is, a destination for the vehicle 1 upon loading. Further, the management system 200 sets a target trajectory (traveling path TP) from the loading area to the target parking space in the parking lot PL. The in-vehicle system 100 acquires information on the target trajectory to the target parking space. The management system 200 issues a loading instruction to the in-vehicle system 100. In response to the loading instruction, the in-vehicle system 100 causes the vehicle 1 to travel to the target parking space in accordance with the target trajectory. In other words, the in-vehicle system 100 controls the vehicle 1 to follow the target trajectory based on the vehicle position. Then, the in-vehicle system 100 causes the vehicle 1 to be parked at the target parking space.

Unloading processing is as follows. Upon unloading, a designated unloading area becomes a destination for the vehicle 1. The management system 200 sets a target trajectory (traveling path TP) from the parking space to the unloading area in the parking lot PL. The in-vehicle system 100 acquires information on the target trajectory to the unloading area. The management system 200 issues an unloading instruction to the in-vehicle system 100. In response to the unloading instruction, the in-vehicle system 100 causes the vehicle 1 to travel to the unloading area in accordance with the target trajectory. In other words, the in-vehicle system 100 controls the vehicle 1 to follow the target trajectory based on the vehicle position. Then, the in-vehicle system 100 causes the vehicle 1 to stop in the unloading area.

2. Management Information

The management system 200 that manages the predetermined area AR holds various kinds of management information.

2-1. Area Management Information

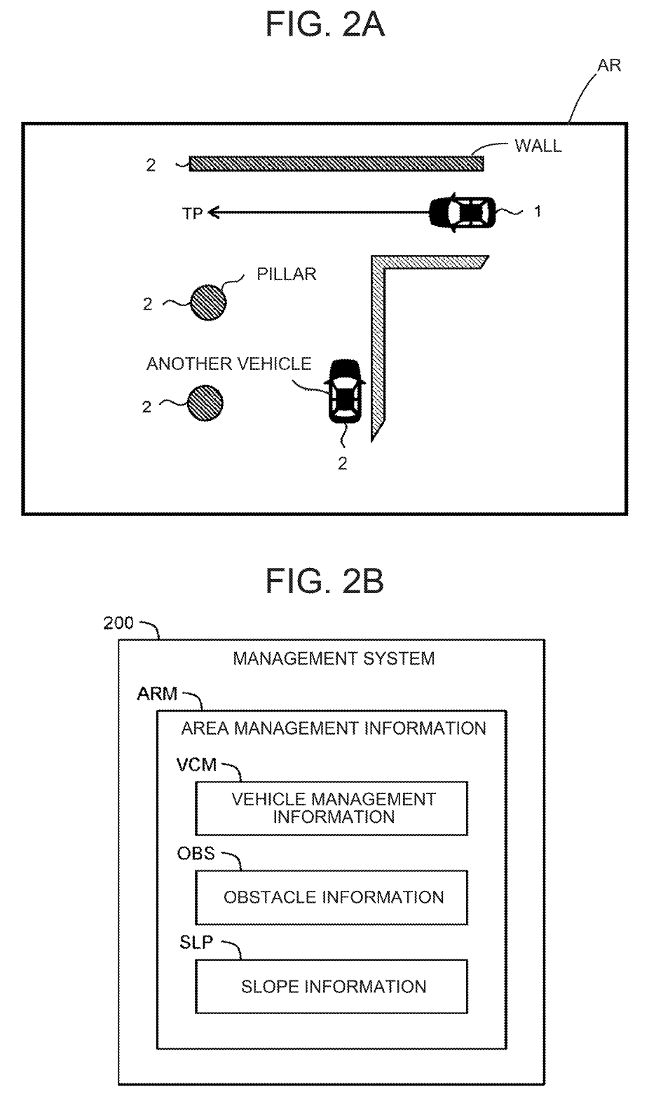

The management system 200 holds area management information ARM for managing the predetermined area AR. In particular, the area management information ARM indicates a condition of the predetermined area AR. FIG. 2A and FIG. 2B are conceptual diagrams for describing an example of the area management information ARM.

For example, the area management information ARM may include vehicle management information VCM for managing each vehicle 1 within the predetermined area AR. The vehicle management information VCM includes position information of each vehicle 1 within the predetermined area AR. The management system 200 may perform communication with each vehicle 1 to collect position information from each vehicle 1. Alternatively, the management system 200 may acquire an image captured by the infrastructure camera CAM provided in the predetermined area AR and estimate the position of each vehicle 1 based on the image.

Further, the vehicle management information VCM may include a traveling path TP to be allocated to each vehicle 1. The management system 200 can determine the traveling path TP to be allocated to the vehicle 1 based on the position information of the vehicle 1, a destination, and map information of the predetermined area AR. The management system 200 may provide information on the traveling path TP of the vehicle 1 to the in-vehicle system 100 of the vehicle 1. Note that the traveling path TP to be allocated to the vehicle 1 is a "scheduled traveling path" through which the vehicle 1 is scheduled to travel.

In a case of the parking lot PL exemplified in FIG. 1 described above, the management system 200 that manages automated valet parking in the parking lot PL accurately grasps the position information and the traveling paths TP (scheduled traveling paths) of all the vehicles 1 within the parking lot PL.

As another example, the area management information ARM may include obstacle information OBS indicating positions (arrangement) of obstacles 2 within the predetermined area AR. The obstacles 2 include a stationary object such as a wall, a pillar and a pole. Position information of the stationary objects within the predetermined area AR is known information. The obstacles 2 may include the vehicle 1. The position information of the vehicle 1 within the predetermined area AR is the same as that included in the vehicle management information VCM described above.

As still another example, the area management information ARM may include slope information SLP indicating slope of roads within the predetermined area AR.

2-2. Access Point Management Information

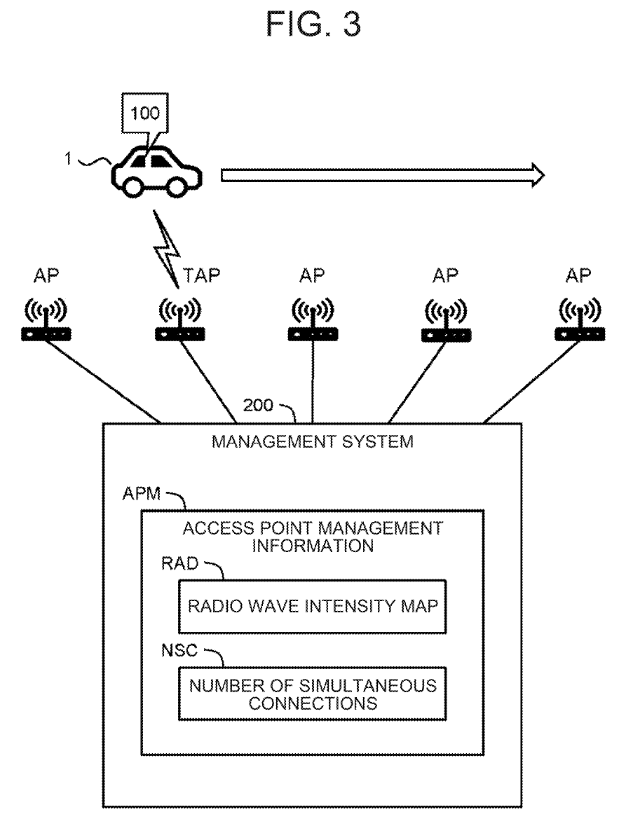

FIG. 3 is a conceptual diagram for describing access points AP provided in the predetermined area AR and access point management information APM. The vehicle 1 (in-vehicle system 100) within the predetermined area AR performs communication with the management system 200 via a wireless communication network. The wireless communication network is a wireless local area network (LAN). Thus, a plurality of access points AP for connecting to the wireless LAN is provided within the predetermined area AR.

A target access point TAP is one of the plurality of access points AP provided in the predetermined area AR, to which the vehicle 1 (in-vehicle system 100) is to be connected. The vehicle 1 (in-vehicle system 100) connects to the target access point TAP and performs wireless communication with the target access point TAP, thereby performing communication with the management system 200 by utilizing the wireless LAN. The vehicle 1 (in-vehicle system 100) may perform vehicle traveling control by communicating various kinds of information with the management system 200. The vehicle 1 (in-vehicle system 100) travels in the predetermined area AR while switching the target access point TAP to be connected.

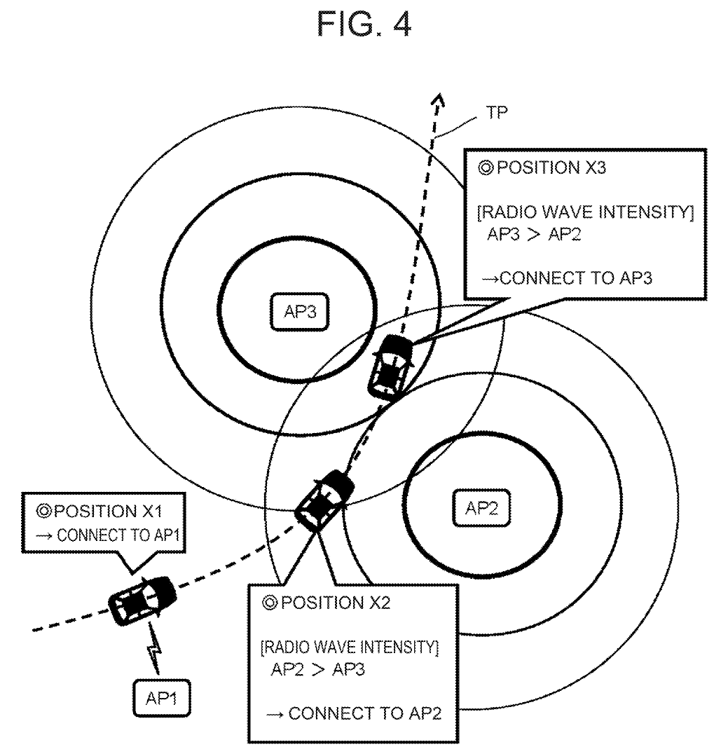

FIG. 4 is a conceptual diagram for describing an example of switching of the target access point TAP. FIG. 4 illustrates a certain vehicle 1, a traveling path TP of the vehicle 1, and access points AP1, AP2, AP3. A radio wave intensity distribution is also indicated for each of the access points AP2, AP3. A circle around each access point AP expresses the radio wave intensity distribution, and a thicker line of the circle means stronger radio wave intensity. The vehicle 1 travels along the traveling path TP. The vehicle 1 is connected to the access point AP1 at a position X1 on the traveling path TP. Then, the radio wave intensity of the access point AP2 becomes stronger on the traveling path TP. At a position X2 on the traveling path TP, the vehicle 1 switches the target access point TAP from the access point AP1 to the access point AP2. At the position X2, the radio wave intensity of the access point AP2 is stronger than the radio wave intensity of the access point AP3. Then, at a position X3 on the traveling path TP, the radio wave intensity of the access point AP3 becomes stronger than the radio wave intensity of the access point AP2. The vehicle 1 switches the target access point TAP from the access point AP2 to the access point AP3.

Referring to FIG. 3 again, the management system 200 that manages the predetermined area AR holds the access point management information APM for managing the access points AP within the predetermined area AR.

The access point management information APM includes a radio wave intensity map RAD. The radio wave intensity map RAD includes information on the radio wave intensity distribution of each of the plurality of access points AP within the predetermined area AR. For example, the radio wave intensity map RAD indicates identification information, a position at which the access point AP is provided within the predetermined area AR, and the radio wave intensity distribution within the predetermined area AR for each access point AP.

For example, the radio wave intensity map RAD provides a "static" radio wave intensity distribution for each access point AP. The static radio wave intensity distribution of the access point AP is determined based on the position at which the access point AP is provided and performance of the access point AP. The performance of the access point AP is specified by a model, radio wave output capability, a radio frequency, and the like. Such a static radio wave intensity distribution can be obtained in advance based on the position at which the access point AP is provided and the performance of the access point AP. Once the radio wave intensity map RAD is created, the same radio wave intensity map RAD can be continuously used. However, when the access point AP is replaced, the radio wave intensity map RAD is updated.

As another example, the radio wave intensity map RAD may provide a "dynamic" radio wave intensity distribution for each access point AP. More specifically, the radio wave intensity distribution can dynamically fluctuate also by a distribution of moving bodies (for example, the vehicles 1) within the predetermined area AR. Thus, the management system 200 may calculate a dynamic radio wave intensity distribution of each access point AP in real time in consideration of the distribution of moving bodies in the predetermined area AR. In other words, the management system 200 may calculate a dynamic radio wave intensity distribution regarding the access point AP in real time based on the distribution of the moving bodies in the predetermined area AR in addition to the position at which the access point AP is provided and the performance of the access point AP. For example, the position information of each vehicle 1 within the predetermined area AR can be obtained from the vehicle management information VCM described above. In particular, in a case of the parking lot PL exemplified in FIG. 1 described above, the management system 200 that manages automated valet parking in the parking lot PL accurately grasps a current distribution (current positions) of all the vehicles 1 within the parking lot PL. Thus, the management system 200 can calculate the dynamic radio wave intensity distribution for each access point AP in real time.

The access point management information APM may include the number of simultaneous connections NSC of each of the plurality of access points AP within the predetermined area AR. For example, the management system 200 performs communication with each access point AP to acquire information on the number of simultaneous connections NSC from each access point AP in real time. The management system 200 manages the information on the number of simultaneous connections NSC collected from each access point AP.

3. Information Processing System

According to the present embodiment, various kinds of processing related to communication using the access point AP is executed. Hereinafter, the processing related to communication using the access point AP will be referred to as "communication-related processing".

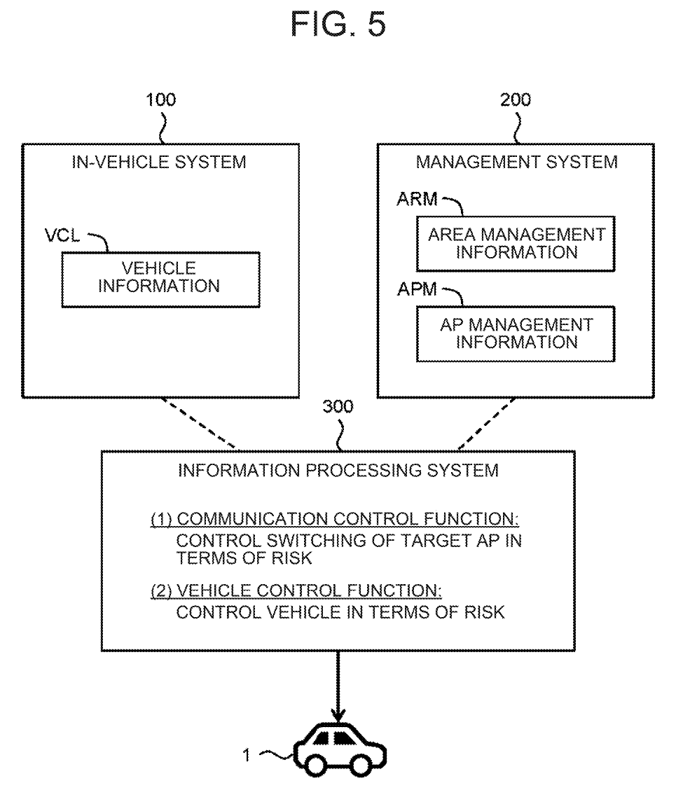

FIG. 5 is a conceptual diagram for describing outline of an information processing system 300 that executes the communication-related processing. The information processing system 300 is applied to the vehicle 1. "Applied to the vehicle 1" means that it is only necessary that a result of the communication-related processing executed by the information processing system 300 be reflected in at least the vehicle 1. For example, the information processing system 300 is included in the in-vehicle system 100. As another example, the information processing system 300 may be included in the management system 200 that can perform communication with the in-vehicle system 100. As still another example, the information processing system 300 may be distributed into the in-vehicle system 100 and the management system 200. As yet another example, the information processing system 300 may be a system which is different from but can perform communication with the in-vehicle system 100 and the management system 200. In either case, the in-vehicle system 100, the management system 200, and the information processing system 300 are configured to be able to share the same information.

The information processing system 300 acquires vehicle information VCL regarding the vehicle 1 from the in-vehicle system 100 of the vehicle 1. For example, the vehicle information VCL includes a position and a speed of the vehicle 1. The vehicle information VCL may include an acceleration (a longitudinal acceleration, a lateral acceleration), a steering angle, and the like, of the vehicle 1. Further, the information processing system 300 acquires the area management information ARM and the access point management information APM from the management system 200. The information processing system 300 executes the communication-related processing based on these kinds of information. Then, the information processing system 300 shares a result of the communication-related processing with the in-vehicle system 100.

One example of the communication-related processing is "communication control processing" of appropriately controlling switching of the target access point TAP. As described above, when the vehicle 1 travels in the predetermined area AR, the vehicle 1 performs wireless communication while switching the target access point TAP. However, wireless communication is interrupted for a moment at a switching timing of the target access point TAP, and thus, it is desired to appropriately control switching of the target access point TAP in accordance with a condition. Thus, for example, in the communication-related processing, switching of the target access point TAP is suppressed at a position at which the risk is high, so that instantaneous interruption of wireless communication at the position at which the risk is high is suppressed. The information processing system 300 can be also said as having a "communication control function" of appropriately controlling switching of the target access point TAP in terms of a risk. The information processing system 300 having such a communication control function can be also referred to as a "communication control system".

Another example of the communication-related processing is encouraging switching of the target access point TAP at a position at which radio wave intensity is weak. Thus, the communication-related processing may include "vehicle control processing" of controlling the vehicle 1 in advance such that the risk becomes low at the position at which the radio wave intensity is weak. The information processing system 300 can be also said as having a "vehicle control function" of appropriately controlling the vehicle 1 in terms of a risk. The information processing system 300 having such a vehicle control function can be also referred to as a "vehicle control system".

The communication-related processing by the information processing system 300 will be described in further detail below.

3-1. Risk Calculation Processing

The vehicle 1 travels on the traveling path TP. A risk RSK is calculated for each target position on the traveling path TP. For example, the target position on the traveling path TP is a current position of the vehicle 1. In this case, the risk RSK at the current position is calculated in real time. As another example, the target position on the traveling path TP may be a future position of the vehicle 1. In this case, the risk RSK at the future position is calculated in advance.

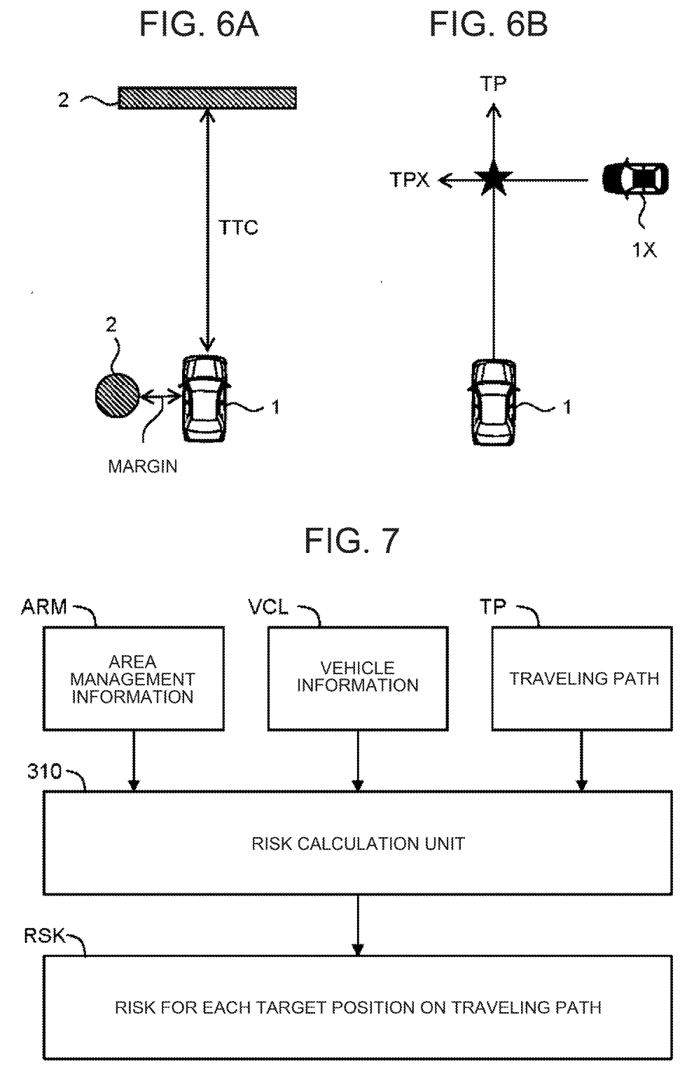

FIG. 6A and FIG. 6B are conceptual diagram for describing examples of the risk RSK. As illustrated in FIG. 6A, for example, as a margin (shortest distance) between the vehicle 1 at the target position and the obstacle 2 around the target position becomes smaller, the risk RSK at the target position becomes higher. As another example, as a time to collision (TTC) between the vehicle 1 at the target position and the obstacle 2 around the target position becomes shorter, the risk RSK at the target position becomes higher. As illustrated in FIG. 6B, as still another example, when the target position is located on a scheduled traveling path TPX of another vehicle 1X, the risk RSK at the target position becomes high.

FIG. 7 is a block diagram illustrating a functional configuration example related to risk calculation processing. The information processing system 300 includes a risk calculation unit 310 that performs the risk calculation processing. The risk calculation unit 310 acquires the area management information ARM, the vehicle information VCL, and information on the traveling path TP of the vehicle 1. The area management information ARM can be obtained from the management system 200. Also, the traveling path TP of the vehicle 1 is set by the management system 200 and can be obtained from the management system 200. The vehicle information VCL can be obtained from the in-vehicle system 100 of the vehicle 1. The risk calculation unit 310 calculates the risk RSK at the target position on the traveling path TP of the vehicle 1 based on these kinds of information.

For example, the risk calculation unit 310 calculates a margin (shortest distance) between the vehicle 1 at the target position and the obstacle 2 around the target position. The area management information ARM includes obstacle information OBS indicating positions (arrangement) of the obstacles 2 within the predetermined area AR. Thus, the risk calculation unit 310 can calculate the margin based on the target position and the obstacle information OBS. Then, the risk calculation unit 310 calculates the risk RSK at the target position based on the margin. Specifically, as the margin (shortest distance) becomes smaller, the risk RSK at the target position becomes higher.

As another example, the risk calculation unit 310 may calculate the time to collision (TTC) between the vehicle 1 at the target position and the obstacle 2 around the target position. The area management information ARM includes the obstacle information OBS indicating the positions (arrangement) of the obstacles 2 within the predetermined area AR. The vehicle information VCL includes the position and the speed of the vehicle 1. The vehicle information VCL may include the acceleration of the vehicle 1. Thus, the risk calculation unit 310 can calculate the TTC based on the vehicle information VCL and the obstacle information OBS. In calculation of the TTC, the slope of the road indicated by the slope information SLP included in the area management information ARM may be taken into account. Then, the risk calculation unit 310 calculates the risk RSK at the target position based on the TTC. Specifically, as the time to collision (TTC) decreases, the risk RSK at the target position becomes higher.

As still another example, the risk calculation unit 310 may determine whether the target position is located on the scheduled traveling path TPX of the other vehicle 1X. The area management information ARM includes vehicle management information VCM indicating scheduled traveling paths of the vehicles 1 (including the other vehicle 1X) within the predetermined area AR. Thus, the risk calculation unit 310 can determine whether the target position is located on the scheduled traveling path TPX of the other vehicle 1X based on the target position and the vehicle management information VCM. Then, the risk calculation unit 310 sets the risk RSK when the target position is located on the scheduled traveling path TPX of the other vehicle 1X higher than the risk RSK when the target position is not located on the scheduled traveling path TPX of the other vehicle 1X.

3-2. Communication Control Processing

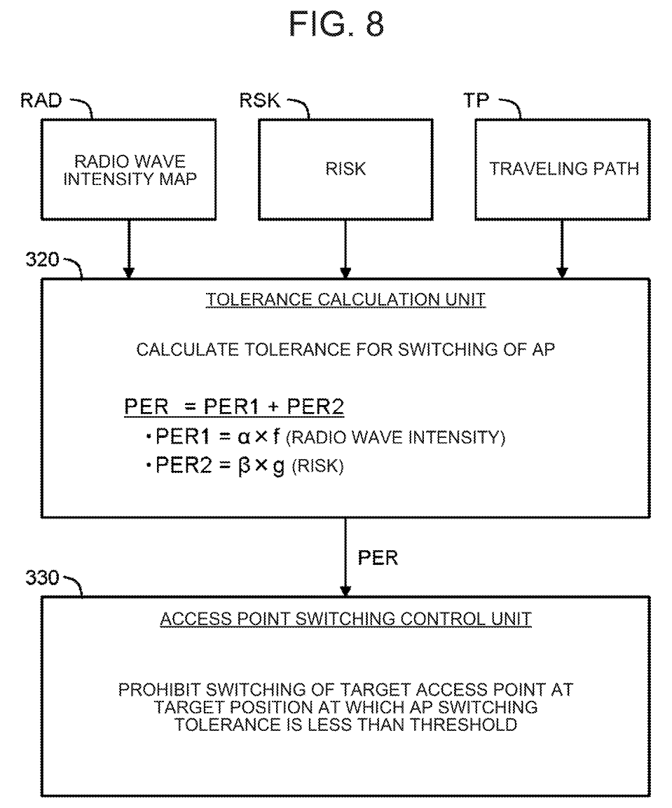

FIG. 8 is a block diagram illustrating a functional configuration example related to communication control processing in which the risk RSK is taken into account. The information processing system 300 includes a tolerance calculation unit 320 and an access point switching control unit 330.

The tolerance calculation unit 320 calculates an access point switching tolerance PER at the target position. The access point switching tolerance PER is a tolerance for switching of the target access point TAP. The access point switching tolerance PER is used to determine whether the target access point TAP may be switched at the target position.

More specifically, the tolerance calculation unit 320 acquires the radio wave intensity map RAD, the risk RSK at the target position, and the information on the traveling path TP of the vehicle 1. The radio wave intensity map RAD includes a radio wave intensity distribution of each access point AP within the predetermined area AR. The radio wave intensity map RAD is included in the access point management information APM and can be obtained from the management system 200. The information on the traveling path TP of the vehicle 1 can be also obtained from the management system 200. The risk RSK at the target position can be obtained from the risk calculation unit 310 described above. The tolerance calculation unit 320 calculates the access point switching tolerance PER at the target position on the traveling path TP of the vehicle 1 based on these kinds of information.

For example, the access point switching tolerance PER includes a first tolerance PER1 and a second tolerance PER2. In other words, the access point switching tolerance PER is a sum of the first tolerance PER1 and the second tolerance PER2 (PER = PER1 + PER2)

The first tolerance PER1 is expressed with a function (f) of the radio wave intensity of the target access point TAP at the target position. For example, PER1 = α × f (radio wave intensity). As the radio wave intensity of the target access point TAP at the target position becomes weaker, the first tolerance PER1 becomes higher. Inversely, as the radio wave intensity of the target access point TAP at the target position becomes stronger, the first tolerance PER1 becomes lower.

The second tolerance PER2 is expressed with a function (g) of the risk RSK at the target position. For example, PER2 = β × g (risk). As the risk RSK at the target position becomes lower, the second tolerance PER2 becomes higher. Inversely, as the risk RSK at the target position becomes higher, the second tolerance PER2 becomes lower.

A weight coefficient α and a weight coefficient β respectively specify a weight of the first tolerance PER1 and a weight of the second tolerance PER2. For example, the weight coefficients α, β are set such that relationships of α + β = 1, 0 < α < 1, 0 < β < 1 are satisfied. Any setting values may be used for the weight coefficients α, β. When emphasis is placed on the radio wave intensity, a relatively great weight coefficient α is set. On the other hand, when emphasis is placed on the risk, a relatively great weight coefficient β is set.

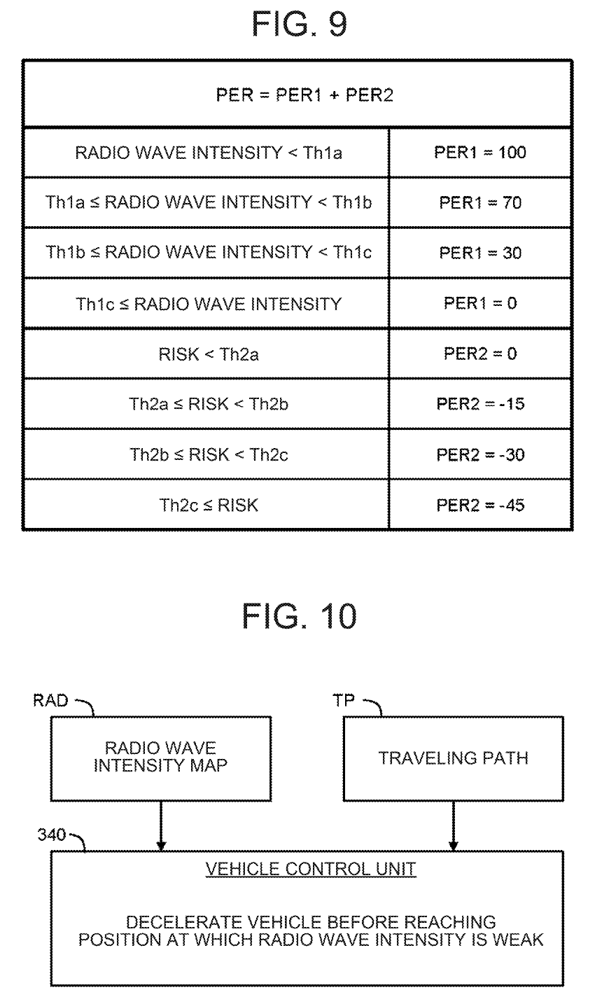

FIG. 9 indicates an example of the access point switching tolerance PER. As the radio wave intensity becomes weaker, the first tolerance PER1 becomes higher stepwise. Inversely, as the radio wave intensity becomes stronger, the first tolerance PER1 becomes lower stepwise. Further, as the risk RSK becomes lower, the second tolerance PER2 becomes higher stepwise. Inversely, as the risk RSK becomes higher, the second tolerance PER2 becomes lower stepwise.

The access point switching control unit 330 controls switching of the target access point TAP in accordance with the access point switching tolerance PER. For example, the access point switching control unit 330 permits switching of the target access point TAP at a certain target position at which the access point switching tolerance PER is equal to or greater than a threshold. On the other hand, the access point switching control unit 330 prohibits switching of the target access point TAP at a certain target position at which the access point switching tolerance PER is less than the threshold. For example, in the example indicated in FIG. 9, the threshold is 50.

As described above, according to the present embodiment, the access point switching tolerance PER at the target position on the traveling path TP of the vehicle 1 is calculated while the "risk RSK at the target position" is also taken into account as well as the radio wave intensity distribution. As the risk RSK at the target position becomes higher, the access point switching tolerance PER becomes lower. Further, switching of the target access point TAP is prohibited at the target position at which the access point switching tolerance PER is less than the threshold. Thus, at the position at which the risk RSK is high, switching of the target access point TAP is suppressed. In other words, at the position at which the risk RSK is high, instantaneous interruption of wireless communication is suppressed. This is preferable in terms of vehicle control.

3-3. Vehicle Control Processing

At a position at which the radio wave intensity is weak, it is desirable to encourage switching of the target access point TAP. It is therefore considered to aggressively reduce the risk RSK at the position at which the radio wave intensity is weak.

FIG. 10 is a block diagram illustrating a functional configuration example related to vehicle control processing in which the risk RSK is taken into account. The information processing system 300 includes a vehicle control unit 340. The vehicle control unit 340 decelerates the vehicle 1 before reaching a position at which the radio wave intensity is weak. The vehicle control unit 340 acquires the radio wave intensity map RAD and the information on the traveling path TP of the vehicle 1. The radio wave intensity map RAD includes the radio wave intensity distribution of each access point AP within the predetermined area AR. The radio wave intensity map RAD is included in the access point management information APM and can be obtained from the management system 200. The information on the traveling path TP of the vehicle 1 can be also obtained from the management system 200.

A first position is a future position of the vehicle 1 on the traveling path TP. For example, the first position is a position a first distance ahead of the current position of the vehicle 1. The first distance is, for example, a fixed distance. As another example, the first distance may be a distance traveled by the vehicle 1 during a first period. The first period is, for example, several seconds.

The vehicle control unit 340 acquires radio wave intensity of the target access point TAP at the first position from the radio wave intensity map RAD. Further, the vehicle control unit 340 compares the radio wave intensity of the target access point TAP at the first position with a first threshold. The first threshold is a threshold for determining that the radio wave intensity is weak. When the radio wave intensity of the target access point TAP at the first position is less than the first threshold, the vehicle control unit 340 decelerates the vehicle 1 before reaching the first position. This can reduce the risk RSK at the first position, in particular, the risk RSK related to the TTC. As a result of this, it can be expected that the access point switching tolerance PER at the first position increases, and the target access point TAP is switched. In this manner, switching of the target access point TAP is encouraged at the position at which the radio wave intensity is weak by the vehicle control processing in which the risk RSK is taken into account.

A second threshold is a threshold for determining that the radio wave intensity is sufficiently strong and is greater than the first threshold described above. When the radio wave intensity of the target access point TAP at the first position is equal to or greater than the second threshold, the vehicle control unit 340 may increase the speed of the vehicle 1 somewhat before reaching the first position. This is because, at the position at which the radio wave intensity is sufficiently strong, neither switching of the target access point TAP nor instantaneous interruption of wireless connection occurs, and thus, it is possible to address the risk in good time. As a result of the speed of the vehicle 1 increasing, a period until the vehicle 1 arrives at the destination is shortened.

4. Configuration Example

4-1. Configuration Example of In-Vehicle System

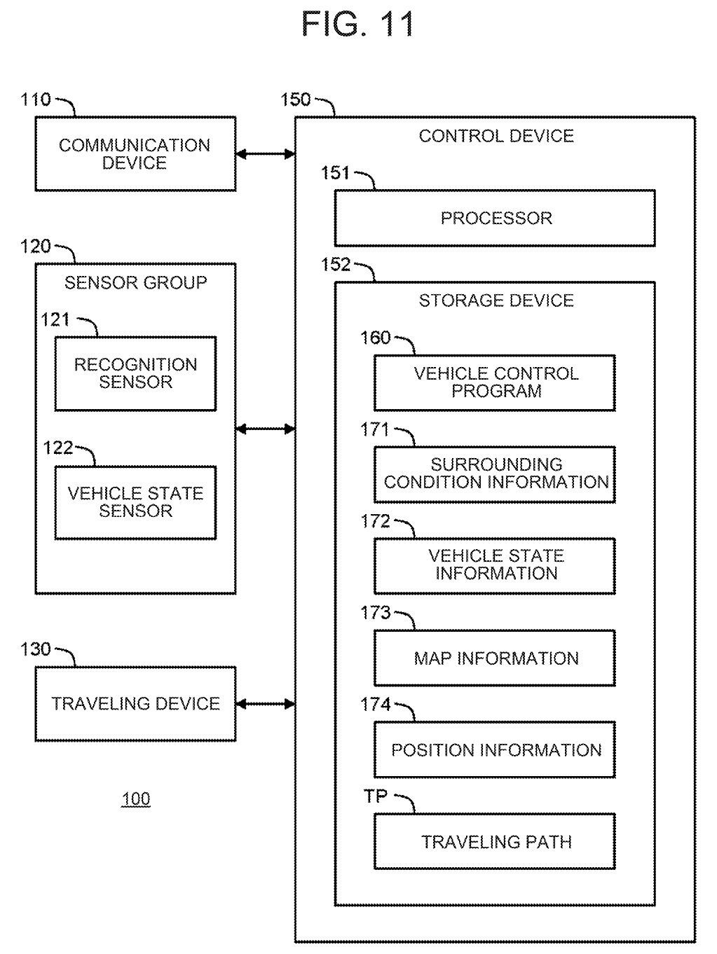

FIG. 11 is a block diagram illustrating a configuration example of the in-vehicle system 100 according to the present embodiment. The in-vehicle system 100 includes a communication device 110, a sensor group 120, a traveling device 130, and a control device 150.

The communication device 110 performs communication with outside via a communication network. For example, the communication device 110 performs communication with the management system 200 in the predetermined area AR via the access point AP of the wireless LAN.

The sensor group 120 includes a recognition sensor 121, a vehicle state sensor 122, and the like. The recognition sensor 121 is utilized to recognize (detect) a condition around the vehicle 1. Examples of the recognition sensor 121 can include a camera, a laser imaging detection and ranging (LIDAR), a radar, and the like. The vehicle state sensor 122 includes a speed sensor, an acceleration sensor, a yaw rate sensor, a steering angle sensor, and the like.

The traveling device 130 includes a steering device, a driving device, and a braking device. The steering device steers wheels. For example, the steering device includes a power steering (electric power steering (EPS)) device. The driving device is a power source for generating driving force. Examples of the driving device can include an engine, an electric motor, an in-wheel motor, and the like. The braking device generates braking force.

The control device 150 is a computer that controls the vehicle 1. The control device 150 includes one or more processors 151 (hereinafter, simply referred to as a processor 151), and one or more storage devices 152 (hereinafter, simply referred to as a storage device 152). The processor 151 executes various kinds of processing. Examples of the processor 151 include a general-purpose processor, an application specific instruction-set processor, a central processing unit (CPU), a graphics processing unit (GPU), an application specific integrated circuit (ASIC), a field-programmable gate array (FPGA), an integrated circuit, and/or a combination thereof. The processor 151 can be also referred to as a processing circuitry. The storage device 152 stores various kinds of information. Examples of the storage device 152 can include a volatile memory, a non-volatile memory, a hard disk drive (HDD), a solid state drive (SSD), and the like.

A vehicle control program 160 is a computer program for controlling the vehicle 1. Functions of the control device 150 may be implemented by coordination of the processor 151 that executes the vehicle control program 160 and the storage device 152. The vehicle control program 160 is stored in the storage device 152. Alternatively, the vehicle control program 160 may be recorded in a computer-readable recording medium.

The control device 150 executes vehicle traveling control of controlling traveling of the vehicle 1. The vehicle traveling control includes steering control, acceleration control, and deceleration control. The control device 150 executes vehicle traveling control by controlling the traveling device 130 (the steering device, the driving device, and the braking device).

The control device 150 acquires various kinds of information. The various kinds of information are stored in the storage device 152.

Surrounding condition information 171 indicates a recognition result by the recognition sensor 121. The surrounding condition information 171 may include object information regarding an object recognized by the recognition sensor 121. Examples of the object around the vehicle 1 can include an obstacle, a white line, a marker M, and the like. Examples of the obstacle can include a wall, a pillar, other vehicles, and the like. Object information indicates a position and a speed of the object relative to the vehicle 1.

Vehicle state information 172 indicates a vehicle state detected by the vehicle state sensor 122. Examples of the vehicle state can include a speed, an acceleration, a yaw rate, a steering angle, and the like.

Map information 173 is map information of the predetermined area AR in which the vehicle 1 travels. The map information 173 indicates arrangement of roads within the predetermined area AR. Further, the map information 173 indicates arrangement of stationary obstacles (for example, a wall, a pillar) within the predetermined area AR. Still further, the map information 173 indicates arrangement of the markers M within the predetermined area AR. For example, the map information 173 is provided from the management system 200 that manages the predetermined area AR. The control device 150 acquires the map information 173 from the management system 200 via the communication device 110.

Position information 174 indicates a current position of the vehicle 1 in the predetermined area AR. For example, the control device 150 acquires high-accuracy position information 174 by localization processing. Specifically, the control device 150 calculates a rough position of the vehicle 1 in the predetermined area AR based on the vehicle state information 172 (the steering angle and the speed). Further, the control device 150 recognizes the markers M around the vehicle 1 using the recognition sensor 121. Still further, the control device 150 acquires arrangement information of the markers M around the vehicle 1 from the map information 173. The control device 150 corrects the position of the vehicle 1 by matching the recognition result of the markers M and the arrangement. By this means, high-accuracy position information 174 can be obtained.

Alternatively, the position information 174 of the vehicle 1 may be estimated by the management system 200 based on the image captured by the infrastructure camera CAM. In this case, the control device 150 may acquire the position information 174 from the management system 200 via the communication device 110.

Note that the vehicle information VCL indicated in FIG. 5 and FIG. 7 described above includes the vehicle state information 172 and the position information 174.

Further, the control device 150 acquires information on the traveling path TP in the predetermined area AR. For example, the management system 200 determines the traveling path TP, and the control device 150 acquires the information on the traveling path TP from the management system 200 via the communication device 110. As another example, the control device 150 may determine the traveling path TP based on the map information 173 and the position information 174. Then, the control device 150 executes vehicle traveling control such that the vehicle 1 travels in accordance with the traveling path TP based on the position information 174.

4-2. Configuration Example of Management System

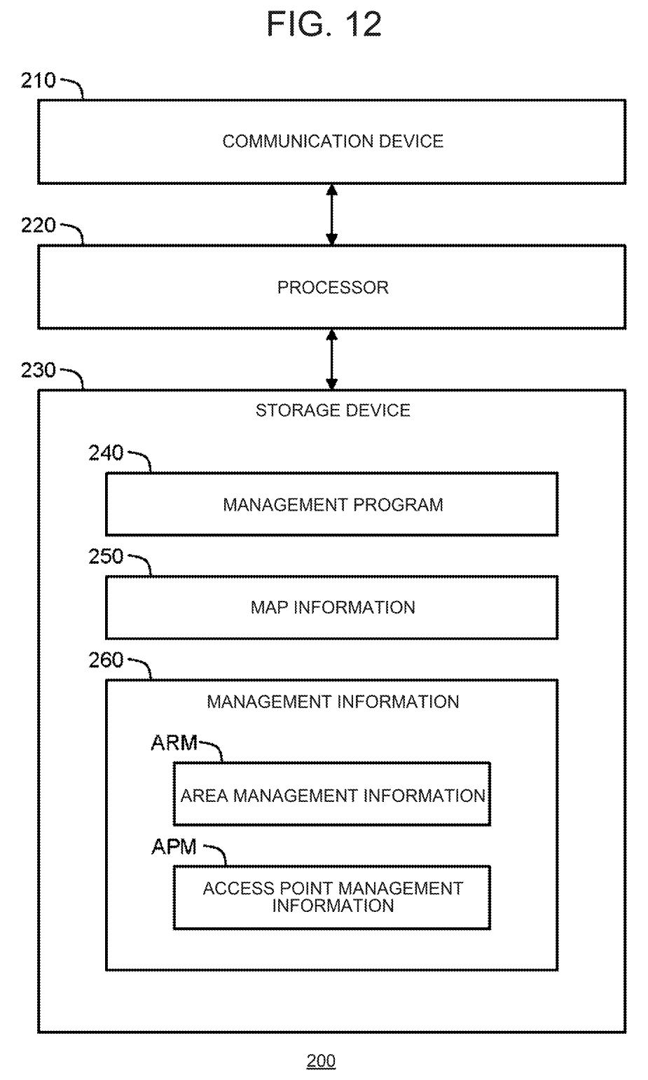

FIG. 12 is a block diagram illustrating a configuration example of the management system 200 according to the present embodiment. The management system 200 includes a communication device 210, one or more processors 220 (hereinafter, simply referred to as a processor 220), and one or more storage devices 230 (hereinafter, simply referred to as a storage device 230).

The communication device 210 performs communication with the in-vehicle system 100 of each vehicle 1. The communication device 210 may perform communication with the infrastructure camera CAM provided in the predetermined area AR. The communication device 210 may perform communication with the access point AP provided in the predetermined area AR.

The processor 220 executes various kinds of processing. Examples of the processor 220 can include a general-purpose processor, an application specific instruction-set processor, a CPU, a GPU, an ASIC, an FPGA, an integrated circuit and/or a combination thereof. The processor 220 can be also referred to as a processing circuitry. The storage device 230 stores various kinds of information. Examples of the storage device 230 can include a volatile memory, a non-volatile memory, an HDD, an SSD, and the like.

The management program 240 is a computer program for managing the predetermined area AR. Functions of the management system 200 may be implemented by coordination of the processor 220 that executes the management program 240 and the storage device 230. The management program 240 is stored in the storage device 230. The management program 240 may be recorded in a computer-readable recording medium.

The storage device 230 stores map information 250 of the predetermined area AR. The map information 250 is similar to the map information 173 described above. The processor 220 may provide the map information 250 to the in-vehicle system 100 via the communication device 210.

Further, the storage device 230 stores management information 260 for managing the predetermined area AR. For example, when the predetermined area AR is the parking lot PL, the management information 260 indicates use conditions (availabilities) of parking spaces within the parking lot PL. The processor 220 can allocate an available parking space (destination) to the vehicle 1 based on the management information 260.

Further, the management information 260 includes the area management information ARM indicated in FIG. 2B. The area management information ARM may include the vehicle management information VCM, the obstacle information OBS, the slope information SLP, and the like.

The vehicle management information VCM includes the position information 174 of each vehicle 1 within the predetermined area AR. The processor 220 may perform communication with each vehicle 1 via the communication device 210 to collect the position information 174 from each vehicle 1. Alternatively, the processor 220 may acquire an image captured by the infrastructure camera CAM provided in the predetermined area AR and estimate the position of each vehicle 1 based on the image.

The vehicle management information VCM may include the traveling path TP to be allocated to each vehicle 1. The processor 220 can determine the traveling path TP to be allocated to each vehicle 1 based on the position information 174 of the vehicle 1, a destination, and the map information 250. The processor 220 may provide the information on the traveling path TP to the in-vehicle system 100 of the vehicle 1 via the communication device 210.

The obstacle information OBS can be obtained from the map information 250 and the vehicle management information VCM.

Further, the management information 260 includes the access point management information APM indicated in FIG. 3. The access point management information APM includes the radio wave intensity map RAD (see FIG. 3). The radio wave intensity map RAD includes information on a radio wave intensity distribution of each of the plurality of access points AP within the predetermined area AR. As described above, the information on the radio wave intensity distribution may be static or dynamic. The vehicle management information VCM described above includes the position information 174 (current position) of each vehicle 1 within the predetermined area AR. By taking into account the position information 174 (current position) of each vehicle 1 within the predetermined area AR, it is possible to calculate a dynamic radio wave intensity distribution for each access point AP in real time.

4-3. Configuration Example of Information Processing System

The information processing system 300 is applied to the vehicle 1 and executes the communication-related processing. For example, the information processing system 300 is included in the in-vehicle system 100. As another example, the information processing system 300 may be included in the management system 200. As still another example, the information processing system 300 may be distributed into the in-vehicle system 100 and the management system 200. As yet another example, the information processing system 300 may be a system which is different from but can perform communication with the in-vehicle system 100 and the management system 200. In either case, the in-vehicle system 100, the management system 200, and the information processing system 300 are configured to be able to share the same information.

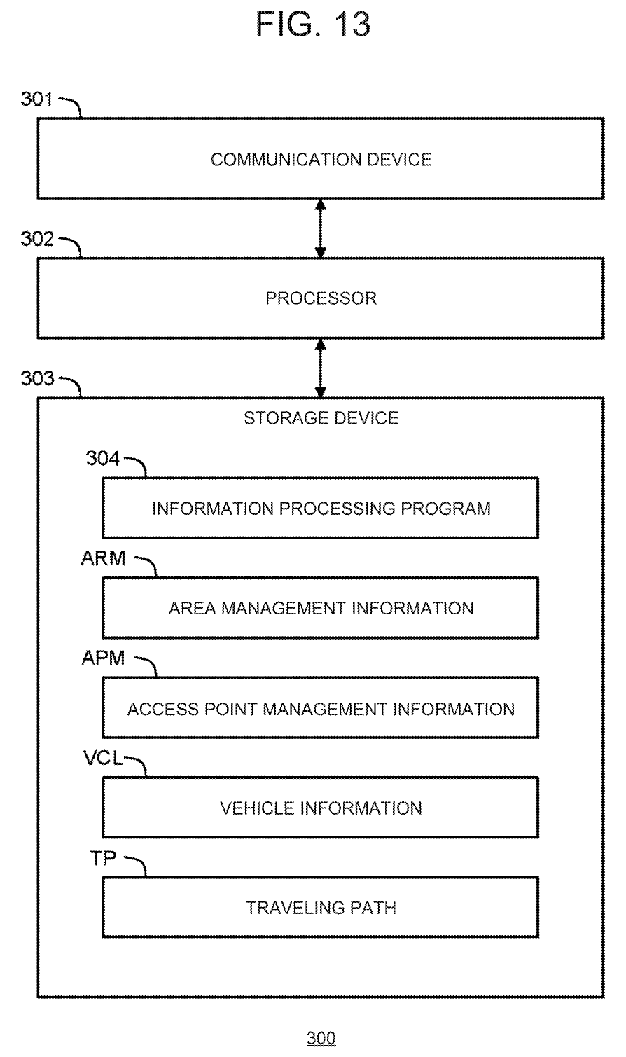

FIG. 13 is a block diagram illustrating a configuration example of the information processing system 300 according to the present embodiment. The information processing system 300 includes a communication device 301, one or more processors 302 (hereinafter, simply referred to as a processor 302), and one or more storage devices 303 (hereinafter, simply referred to as a storage device 303).

The communication device 301 performs communication with outside of the information processing system 300. The communication device 301 may be included in the communication device 110 of the in-vehicle system 100. The communication device 301 may be included in the communication device 210 of the management system 200.

The processor 302 executes various kinds of processing. Examples of the processor 302 include a general-purpose processor, an application specific instruction-set processor, a CPU, a GPU, an ASIC, an FPGA, an integrated circuit, and/or a combination thereof. The processor 302 can be also referred to as a processing circuitry. The processor 302 may be included in the processor 151 of the in-vehicle system 100. The processor 302 may be included in the processor 220 of the management system 200.

The storage device 303 stores various kinds of information. Examples of the storage device 303 can include a volatile memory, a non-volatile memory, an HDD, an SSD, and the like. The storage device 303 may be included in the storage device 152 of the in-vehicle system 100. The storage device 303 may be included in the storage device 230 of the management system 200.

An information processing program 304 is a computer program for executing information processing. The information processing program 304 can be also referred to as a communication control program of executing communication control processing. The information processing program 304 can be also referred to as a path determination program of executing path determination processing. Functions of the information processing system 300 may be implemented by coordination of the processor 302 that executes the information processing program 304 and the storage device 303. The information processing program 304 is stored in the storage device 303. The information processing program 304 may be recorded in a computer-readable recording medium.

The processor 302 acquires the area management information ARM and the access point management information APM from the management system 200. Further, the processor 302 acquires the information on the traveling path TP from the management system 200. Still further, the processor 302 acquires the vehicle information VCL from the in-vehicle system 100. The acquired information is stored in the storage device 303. The processor 302 executes the communication-related processing described above in Section 3 based on the acquired information.

What is claimed is:

1. An information processing system to be applied to a vehicle that travels in a predetermined area in which a plurality of access points is provided, the information processing system comprising:
one or more processors; wherein:
the one or more processors are configured to:
acquire information on a radio wave intensity distribution of each of the plurality of access points;
acquire area management information indicating a condition of the predetermined area;
acquire information on a traveling path of the vehicle in the predetermined area;
calculate a risk at a target position on the traveling path based on at least the area management information;
calculate an access point switching tolerance at the target position based on the radio wave intensity distribution and the risk; and
prohibit switching of a target access point to which the vehicle is to be connected at the target position at which the access point switching tolerance is less than a threshold; and
the access point switching tolerance at the target position becomes lower as the risk at the target position becomes higher.

2. The information processing system according to claim 1, wherein:
the area management information includes obstacle information indicating a position of an obstacle within the predetermined area;
the one or more processors are further configured to calculate a margin between the vehicle at the target position and the obstacle around the target position; and
the risk at the target position becomes higher as the margin at the target position becomes smaller.

3. The information processing system according to claim 1, wherein:
the area management information includes information on a scheduled traveling path of another vehicle within the predetermined area; and
the risk when the target position is located on the scheduled traveling path is higher than the risk when the target position is not located on the scheduled traveling path.

4. The information processing system according to claim 1, wherein:
the area management information includes obstacle information indicating a position of an obstacle within the predetermined area;
the one or more processors are further configured to:
acquire vehicle information including at least a position and a speed of the vehicle; and
calculate a time to collision (TTC) between the vehicle at the target position and the obstacle around the target position based on the obstacle information and the vehicle information; and
the risk at the target position becomes higher as the TTC at the target position decreases.

5. The information processing system according to claim 4, wherein:
a first position is a future position of the vehicle on the traveling path; and
the one or more processors are configured to decelerate the vehicle before reaching the first position when radio wave intensity of the target access point at the first position is less than a first threshold.

6. The information processing system according to claim 1, wherein:
the predetermined area is a parking lot; and
the vehicle includes a function of automated valet parking.

7. An information processing method to be executed by a computer and to be applied to a vehicle that travels in a predetermined area in which a plurality of access points is provided,
the information processing method comprising:
acquiring information on a radio wave intensity distribution of each of the plurality of access points;
acquiring area management information indicating a condition of the predetermined area;
acquiring information on a traveling path of the vehicle in the predetermined area;
calculating a risk at a target position on the traveling path based on at least the area management information;
calculating an access point switching tolerance at the target position based on the radio wave intensity distribution and the risk; and
prohibiting switching of a target access point to which the vehicle is to be connected at the target position at which the access point switching tolerance is less than a threshold,
wherein the access point switching tolerance at the target position becomes lower as the risk at the target position becomes higher.

8. A non-transitory storage medium that stores instructions to be applied to a vehicle that travels in a predetermined area in which a plurality of access points is provided, the instructions being executed by a computer and causing the computer to perform functions comprising:
acquiring information on a radio wave intensity distribution of each of the plurality of access points;
acquiring area management information indicating a condition of the predetermined area;
acquiring information on a traveling path of the vehicle in the predetermined area;
calculating a risk at a target position on the traveling path based on at least the area management information;
calculating an access point switching tolerance at the target position based on the radio wave intensity distribution and the risk; and
prohibiting switching of a target access point to which the vehicle is to be connected at the target position at which the access point switching tolerance is less than a threshold,
wherein the access point switching tolerance at the target position becomes lower as the risk at the target position becomes higher.
